(19) United States
(12) Patent Application Publication
(10) Pub. No.: US 2025/0298524 A1
(43) Pub. Date: Sep. 25, 2025

(54) IN-SITU STOCHASTIC COMPUTING IN MEMORY

(71) Applicant: The Regents of the University of California, Oakland, CA (US)

(72) Inventors: Sudhakar Pamarti, Irvine, CA (US); Jiyue Yang, Los Angeles, CA (US)

(21) Appl. No.: 19/086,032

(22) Filed: Mar. 20, 2025

Related U.S. Application Data
(60) Provisional application No. 63/567,531, filed on Mar. 20, 2024.

(51) Int. Cl. G06F 3/06; G06V 10/94; H04N 25/47

(52) U.S. Cl. CPC G06F 3/0625; G06F 3/0659; G06F 3/0673; G06V 10/955; H04N 25/47

(57) ABSTRACT

Disclosed herein are systems and methods for stochastic computing in memory (SCIM). A SCIM system includes one or more stochastic number generators embedded in a memory array, a processor, and a memory. The memory receives a plurality of data slices. A first dot product is calculated for a first data slice in the plurality of data slices using a first set of operands. The first set of operands is received and stored in a binary representation. The first set of operands is converted into binary stochastic bitstreams using the one or more embedded stochastic number generators.

### CROSS-REFERENCE TO RELATED APPLICATIONS

This application claims priority to U.S. Provisional Patent Application Ser. No. 63/567,531 filed Mar. 20, 2024, the content of which is hereby incorporated by reference in its entirety.

### STATEMENT REGARDING FEDERALLY SPONSORED RESEARCH

This invention was made with government support under FA8650-18-2-7867 awarded by the Air Force Office of Scientific Research (AFOSR). The government has certain rights in the invention.

### BACKGROUND

Stochastic computing (SC) performs arithmetic with numbers represented as fraction (or probability) of 1s in a random binary stream. This representation results in compact compute units (e.g., multiply and accumulate (MAC) units), which enables massive parallelization of compute with associated energy and latency improvements compared to fixed-point implementations of comparable precision.

Compute in memory (CIM) is an emerging technique that performs MAC computations directly within memory arrays e.g., in SRAM, DRAM, NVM etc. Performing compute inside the memory array reduces the data movement requirements with attendant energy and latency improvements. However, CIM techniques are plagued by the need for analog-to-digital converters (ADCs) that are area and power hungry. Stochastic computing in memory (SCIM) combines the above approaches realizing the benefits offered by both. However, SCIM stores entire, unrolled, SC sequences of one set of the operands of the MACs, resulting in large SCIM macros and a poor area efficiency (TOPS/mm2) of the system.

### SUMMARY OF THE DISCLOSURE

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects, the present disclosure can provide a stochastic computing in memory (SCIM) system. The SCIM system can include one or more stochastic number generators embedded in a memory array, a processor, and a memory. The memory can be configured to receive a plurality of data slices. A first dot product can be calculated for a first data slice in the plurality of data slices using a first set of operands. The first set of operands can be received and stored in a binary representation. The first set of operands can be converted into binary stochastic bitstreams using the one or more embedded stochastic number generators.

In further aspects, the present disclosure can provide a method for performing stochastic computing. A plurality of data slices can be received. A first dot product for a first data slice in the plurality of data slices can be calculated using a first set of operands. The first set of operands can be received and stored in a binary representation. The first set of operands can be converted into binary stochastic bitstreams using one or more embedded stochastic number generators.

In further aspects, the present disclosure can provide a stochastic computing in memory (SCIM) system for object detection. The SCIM system can include an image sensor, a processor electrically coupled to the image sensor, and a memory. The memory can receive a set of binary operands obtained by the image sensor. The set of binary operands can be converted to a stochastic bitstream using a stochastic number converter. An output can be determined based on the stochastic bitstream. An image corresponding to the set of binary operands can be reconstructed based on the output.

The foregoing and other aspects and advantages of the present disclosure will appear from the following description. In the description, reference is made to the accompanying drawings that form a part hereof, and in which there is shown by way of illustration one or more exemplary versions. These versions do not necessarily represent the full scope of the disclosure.

### BRIEF DESCRIPTION OF THE DRAWINGS

The following drawings are provided to help illustrate various features of non-limiting examples of the disclosure, and are not intended to limit the scope of the disclosure or exclude alternative implementations.

FIG. 1 is a block diagram conceptually illustrating a stochastic computing system in accordance with the present disclosure.

FIG. 2 is a flow diagram illustrating an example process for performing early termination during stochastic computing in accordance with the present disclosure.

FIG. 3 illustrates an event camera concept, object tracking using convolutional filters, accelerator architecture, and a comparison of stochastic computing methods in accordance with the present disclosure.

FIG. 4 illustrates an in-situ stochastic number generating for converting stored signed weights to stochastic numbers in accordance with the present disclosure.

FIG. 5 illustrates an SCIM marco in accordance with the present disclosure.

FIG. 6 illustrates early termination of a stochastic computing system in accordance with the present disclosure.

FIG. 7 illustrates a characterization of stochastic computing compute errors in accordance with the present disclosure.

FIG. 8 illustrates a summary and comparison table in accordance with the present disclosure.

### DETAILED DESCRIPTION OF THE PRESENT DISCLOSURE

This invention proposes an “in-situ stochastic computing in memory” approach that solves the aforementioned problem with SCIM. Specifically, it stores one set of the operands in binary (fixed-point) format, and employs an “in-situ” binary to stochastic number converter to generate the SC sequences on the fly. The binary to stochastic number converter is highly compact and fits easily within a memory array's row. It is coupled with a high density SC MAC circuit to greatly improve the reuse of the SC sequence so generated thereby amortizing the area and energy costs of the binary to SC sequence generator.

Described herein are designs and hardware implementations of in-situ SCIM, and illustrates its use in an example (low latency object tracking) application. Also illustrated are hardware prototype measurement results, indicating performance improvements. For instance, in some examples, the systems and methods described herein can demonstrate a 25× improvement in the processing speed of event camera data.

Event camera is a bio-inspired imaging technology that responds to the change of brightness asynchronously. It can support very low latency in object tracking applications such as obstacle avoidance for Micro-Aerial Vehicles (MAV) and military systems. However, this unconventional camera poses serious challenges of throughput and energy efficiency for hardware. In some examples, researchers have concluded that MAVs need to respond in milli seconds to avoid obstacles moving faster than 10 m/s, which requires hardware to process >100 M events/s for a 640×480 camera. Costly data movement and slow ADCs respectively limit the processing speeds (event/s) of von Neumann digital architectures (CPU/GPU) and emerging analog Compute-In-Memory (CIM) accelerators. Event cameras can remove texture-rich backgrounds and preserve moving objects, which make convolutional filters highly efficient and effective. Described herein is a filter-based object tracking processor for event camera that embeds compact digital Stochastic Computing (SC) logic in memory to achieve 278 M event/s.

### Example In-Situ Stochastic Computing in Memory (SCIM) Model Implementation System

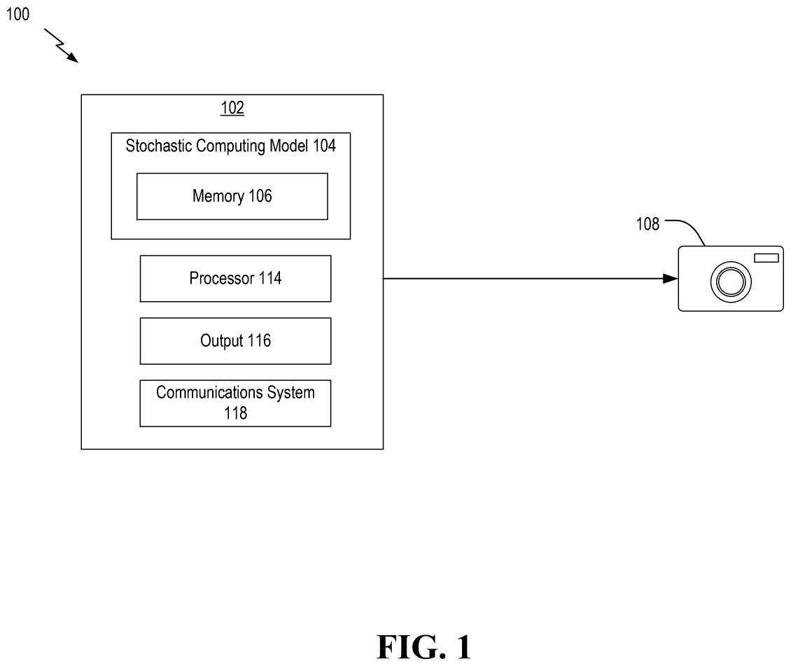

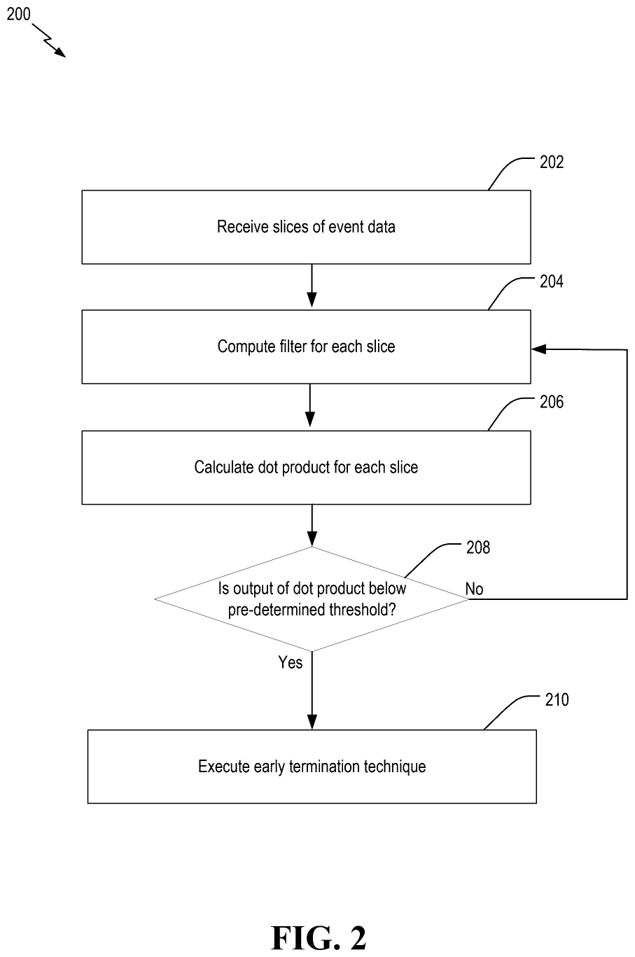

FIG. 1 is a block diagram conceptually illustrating a stochastic computing system 100, according to some embodiments. In some examples, the system 100 may include a computing device 102 with a stochastic computing model 104. In some examples, the computing device 102 may be a resource-constrained device. For example, the device 102 may a single-board computer, a computing chip, a router, a camera, or any suitable computing device. Furthermore, the process described below with respect to FIG. 2, may be tied to steps performed by a device containing the stochastic computing model 104.

In some examples, the computing device 102 can obtain data from a sensor 108 (such as a camera) or other connected device. The data may be obtained via a communication network, or a direct connection between the computing device 102 and the sensor 108. In some examples, a frame (e.g., the first frame, the second frame, etc.) of frame data from sensor 108 can include an image, a video frame, or any other suitable frame data or frame-like data.

As depicted, the sensor 108 may comprise a camera. As will be understood from the description herein, the sensor 108 may be a standalone sensor, or may be a variety of types of cameras. For example, sensor 108 may be an event camera or a grey-scale camera.

The computing device 102 can further include, or be connected to, a stochastic computing model 104. The stochastic computing model 103 may contain a memory 106. The memory 106 can be used to store suitable data (e.g., data from sensor 108) and instructions that can be used, for example, by the processor 114. The stochastic computing model 104 may be “onboard” the same device as the sensor 108, or may be a model of a separate device connected to the computing device 102. In some examples, methods for processing data of sensor 108 for object tracking acceleration and early termination (as described below) may operate as its independent processes/modules. The memory 106 can include any suitable volatile memory, non-volatile memory, storage, or any suitable combination thereof.

In some examples, the computing device 102 can further include an output 116. The output 116 can include a set of output pins to output a prediction or classification. In some examples, the output 116 can further include a display to output prediction or result of a calculation. In some embodiments, the output 116 may be disclosed via any suitable display devices, such as a computer monitor, a touchscreen, a television, an infotainment screen, etc. to display a report containing a classification or prediction.

In some examples, the computing device 102 may be an FPGA-style or a dedicated ASIC chip. The stochastic computing model 104 may be created to account for varying sizes, speeds, power consumptions, and functionalities of the corresponding device 102 or associated computing task. For example, the computing device 102 may be a general purpose FPGA, a high performance FPGA, a low power FPGA, a system-on-chip FPGA, a rad-tolerant FPGA, an application specific FPGA, a high speed FPGA, or the like.

Moreover, the device 102 may use the stochastic computing model 104 to performance of computational or predictive tasks associated with a neural network model. The computing device 102 can be used to perform prediction or computations based on data received from a connected device or database (such as sensor 108). The computing device 102 can receive a dataset or computation request via a communication system 118. The communications system 118 can include any suitable hardware, firmware, and/or software for communicating information over any suitable communication networks. For example, the communications system 118 can include one or more transceivers, one or more communication chips and/or chip sets, etc. In a more particular example, the communications system 118 can include hardware, firmware and/or software that can be used to establish a Wi-Fi connection, a Bluetooth connection, a cellular connection, an Ethernet connection, etc.

In some embodiments, the computing device 102 may further contain a processor 114. The processor 114 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc.

### Example Object Tracking Accelerator and Early Termination Process

FIG. 2 is a flow diagram illustrating an example process 200 for performing early termination (ET) during stochastic computing, according to some embodiments. As described below, a particular implementation can omit some or all illustrated blocks, techniques, or steps, may be implemented in some embodiments in a different order, and may not require some illustrated features to implement all embodiments. In some examples, the systems and devices in connection with FIG. 1 can be used to perform all or part of example process 200. However, it should be appreciated that other suitable processing hardware for carrying out the operations or features described below may perform process 200.

At process block 202, slices of event data are received. In some examples, the event data may correspond to data received from an event camera, or a grey-scale camera. For example, the event data may be from a sensor, such as sensor 108, as described above with respect to FIG. 1. The slices of event data may correspond to single- or multi-bit frames or events. In some examples, the slices of event data may include one or more slices of binary operands.

At process block 204, a filter for each slice is computed. In some examples, the filter may be a convolution filter, such as Gabor linear filter. The filter may include any applicable filter for image processing and computer vision. For example, any filter that may perform texture analysis, edge detection, and feature extraction may be used. In some examples, the filter may correspond to a direction and speed associated with a slice of event data.

At process block 206, a dot product is calculated for each slice. The dot products may perform element-wise summing operations, which may be used to calculate an output a convolution operation. The dot product may correspond to whether a feature is detected an image or frame (i.e. within the event data). In some examples, the values used to calculate the dot product may vary based on a specific input and associated weight.

At process block 208, it is determined if the output of the dot product is below pre-determined threshold. If the output is below the threshold, the process 200 continues to process block 210. If the output is above the threshold, additional slices continue to be processed at block 204. In some examples, the threshold corresponds to a condition being sparse, versus indicating an event or movement occurrence.

At process block 210, an early termination technique is executed. In some examples, the early termination technique may include stopping a dot product level, stopping an additional filter from being processed, or stopping an entire computation. For example, the early termination may allow the system to skip unnecessary computations from occurring in high-sparsity events.

### Example Embodiments and Experiments

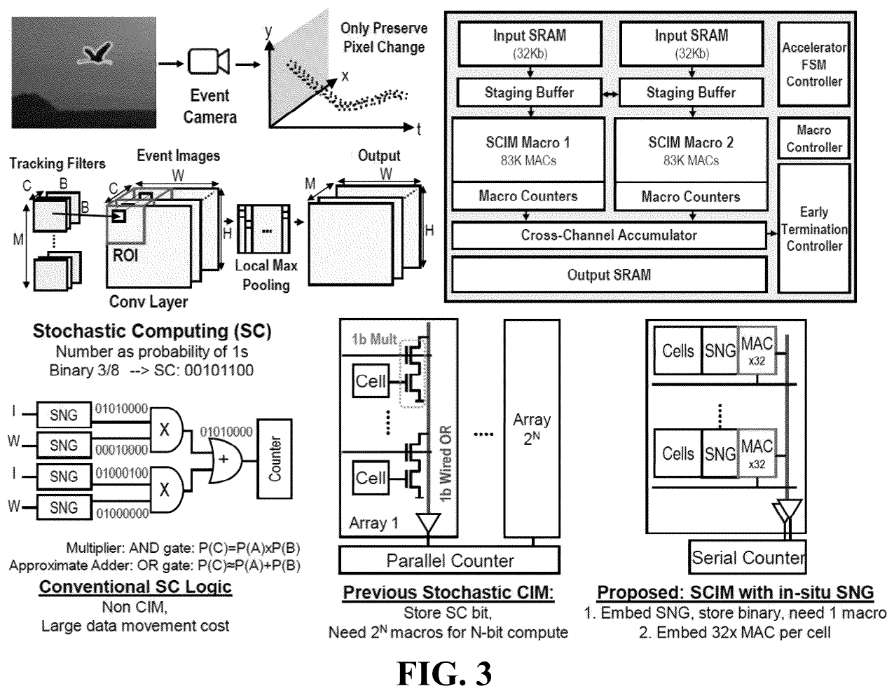

Stochastic Computing (SC) is a computing paradigm that represents numbers as fraction of Is in pseudorandom bit streams. SC uses compact digital logic (e.g., AND gates as multipliers and OR gates as approximate accumulators) to achieve high parallelism and throughput. An in-memory SC CNN processor (FIG. 3) stores pre-converted SC stream bits in memory (2^{N} long for N-bit) to reduce memory access cost but the long SC streams require a large area. In some examples, three innovations may be observed that help achieve the high throughput required by event cameras: 1) An in-situ Stochastic Number Generator (SNG) that converts stored binary numbers to SC streams directly in memory to avoid storing long SC bit stream (see, e.g., FIG. 3), 2) a dense in-memory MAC array that achieves 32 MAC units per weight stored, and 3) an early termination technique to skip unnecessary computation for high-sparsity events that achieves 1.9× reduction in both energy and time.

The SCIM accelerator for event camera is shown in FIG. 3. The event data are typically processed either as 1-bit event to maintain high temporal resolution or accumulated as multi-bit dense frame to reduce throughput requirement. This hardware supports both event and dense frame processing. For event processing, the accelerator's two SCIM macros process two pre-processed time channels in parallel. Each macro has an input buffer using 32 Kb SRAM. The SCIM macro stores 32 convolutional (e.g., Gabor) 6b filters, and computes dot-product with 32×9 pixels unrolled to 32 input sliding windows of 9×9. The macro's outputs are combined to realize 9×9×2 filters, effectively computing convolution sliding across 9×32 pixels in parallel. It takes 9 groups of 64 clock cycles each to completely process 32×9 pixels which translates to a peak throughput of 278 Mevents/s running at 600 MHz. In some examples, the system can achieve the energy efficiency of 158 TOPS/W. The accelerator can also be configured to perform 9×9×1 processing on 6b dense frames.

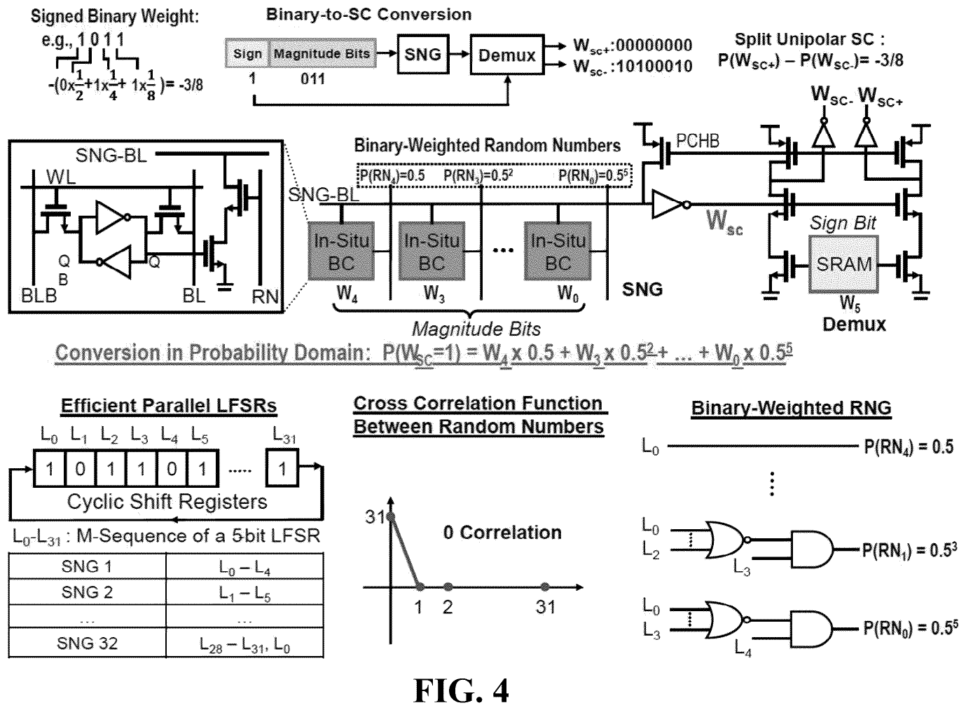

The proposed in-situ SNG can accurately convert binary to stochastic numbers in memory to save area, as illustrated in FIG. 4. SRAM cells store 6b binary weights. The magnitude bits, W0-W4, are multiplexed by random streams, RN₀-RN₄, with binary weighted means, (1/2¹-1/2⁵), using a wired-OR to generate the desired stochastic bit stream W_{sc}. The sign bit, W₅, is used to control the demultiplexer from W_{sc} to W_{sc}+/W_{sc}−, such that P(W_{sc}+)−P(W_{sc}−) represents a signed value. Each cell may only use two extra transistors for multiplexing. The maximal length LFSR pseudo-random sequence with an extra zero state is stored in cyclic shift registers with minimal hardware and has an autocorrelation of 0, as further illustrated in FIG. 4. The LFSR states are uniformly distributed and makes the in-situ stochastic number generation accurate. The random binary weighted streams, RN₀-RN₄, in each SNG are generated using a different set of five bits from the shift registers e.g., L₀-L₄ for SNG1, L₁-L₅ for SNG2 etc. Since stochastic streams in different dot products do not interact, random numbers are shared by SNGs in the same row without correlation.

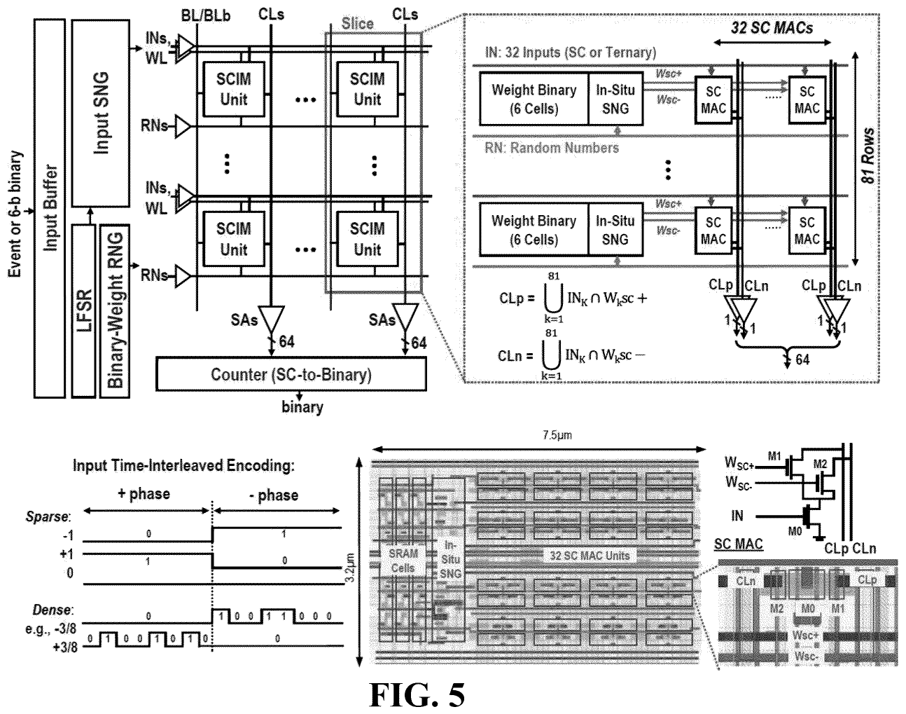

A massive number (32) of MACs are embedded for every stored weight to increase parallelism. Since SC's MAC operation generates one bit at a cycle and may only requires a sense amplifier at the compute line, the sensing circuit may only require 10% area overhead, as shown in FIG. 5. The macro supports both 1b event and 6b binary inputs. In-situ SNG converts weight to stochastic bits and share with 32 MAC units, which use 3 NMOS transistors to perform 2 AND-multiplication between W_{sc}+/W_{sc}− and input IN. The layout picture of an SCIM unit is shown in FIG. 5: 32 input lines are routed with minimal spacing across the SCIM unit while 81 rows form an 81-long dot product at each compute line (CLp/CLn), which performs a 1-bit wired-OR operation. The sense amplifier converts 1-bit OR accumulation output (High/Low) and only accounts for 10% of macro area. The “bank counters” accumulate CLp and CLn over 64 clock cycles (for 6-bit binary output) and compute the difference to generate binary MAC output. The inputs employ time-interleaved encoding where positive (negative) streams are serially applied in the 1st (2nd) phases respectively. The sign of CLp and CLn accumulation is flipped during the negative phase accordingly to realize bipolar MACs. Overall, each slice stores one convolution filter and macro computes 1024 81-long MAC units, occupying only 0.16 mm². Note that input SNGs are also included but are enabled only when processing 6-b inputs from frame-based cameras.

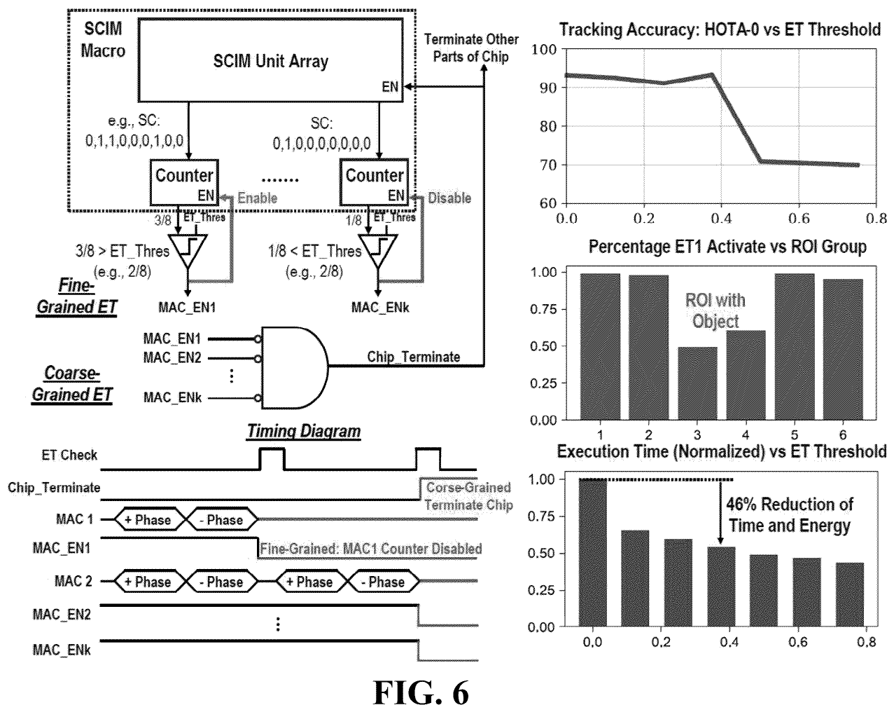

Event camera's data can have high sparsity (>99%) in the region where no object is moving. An Early Termination (ET) technique is proposed to reduce unnecessary computation. In-memory SC logic's energy consumption scales proportional to inputs' switching activity. Synchronous logic or clock buffer energy, however, start to dominate the system energy when macro consumes very little energy. A 2-step fine/coarse-grained ET can be used to turn off inactive components or entire chip to save time and energy, as illustrated in FIG. 6. When the SC MAC's output bit stream is generated serially, the counter converts the partial stream into binary value at the same time, reflecting a preliminary result. The fine-grained ET checks the counter results and clock-gates the counter by MAC_EN signal if the preliminary result does not reach a threshold. For coarse-grained ET, if all the counter units in the macro meet the criteria of fine-grained ET, the object is unlikely to show up in this region of interest (ROI) and the entire chip's operation can be terminated. The chip will move on to compute the next ROI to save energy and time. The threshold of the ET can be set to trade off tracking accuracy and energy consumption, as also illustrated by FIG. 6. In an evaluation of tracking a flying bird in front of an event camera, the tracking score HOTA-0 maintains above 90 for thresholds less than 0.4, achieving energy and time saving of 46%. The higher threshold trades off energy/time savings with accuracy.

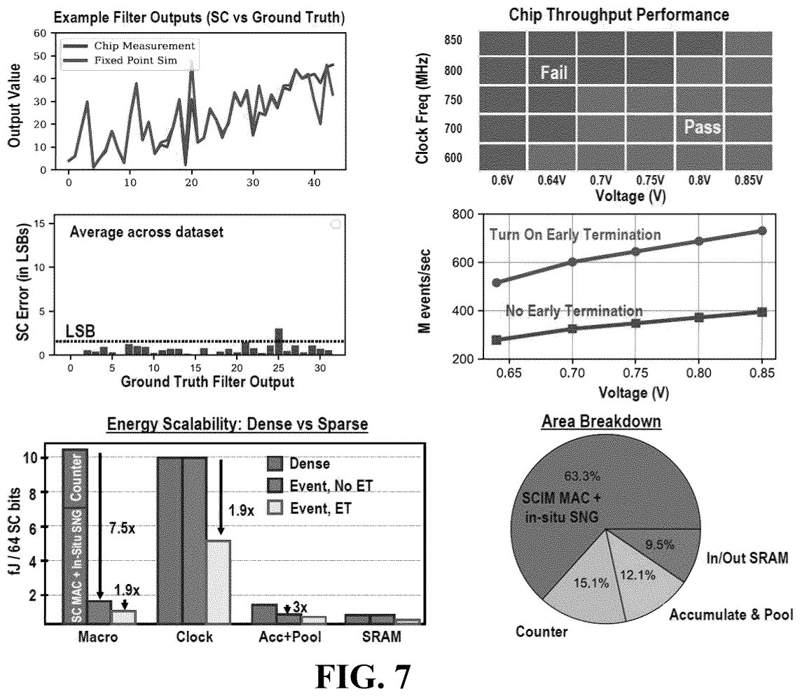

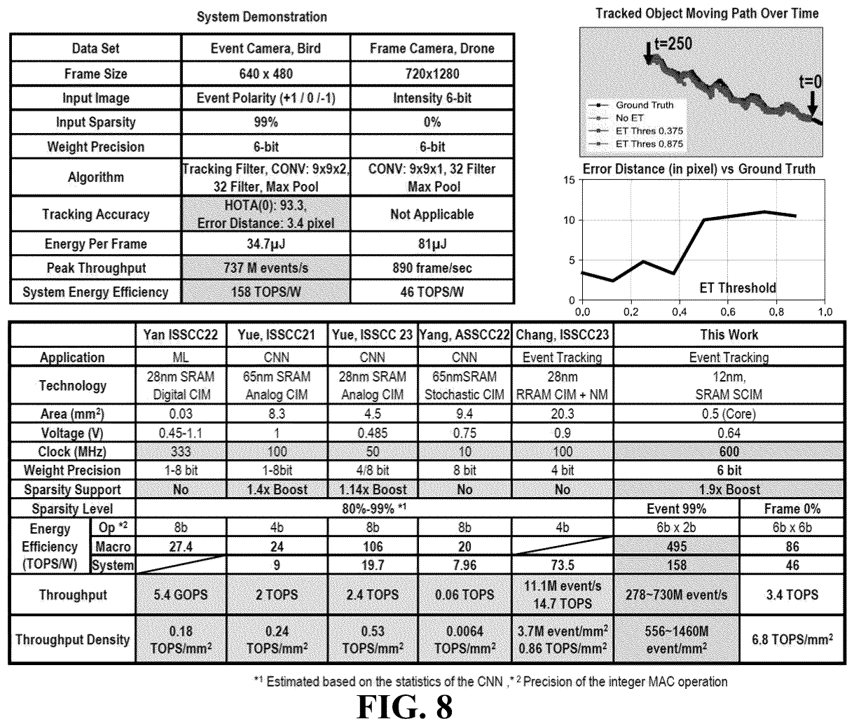

In one example, a prototype chip was fabricated using GF12 nm LP technology with a core area of 0.5 mm². The system operates at 600˜850 MHz under VDD of 0.64V˜0.85V. The measured energy characterization and area breakdown are shown in FIG. 7. Object tracking is demonstrated under event processing mode using a data set of a high-speed flying object. The inputs are convolved with 32 spatio-temporal Gabor filters corresponding to 8 directions and 4 speeds, followed by a column-based max pooling. Tracking accuracy is established both at the MAC level and entire tracking pipeline. The error between measured SC dot-products and 6b FP ground truth, averaged over the entire dataset is mostly less than 1 LSB, as also shown in FIG. 7. While larger errors can occur for due to saturation of the OR-based accumulator, they are rare and have negligible impact as show by the measured non-zero SC dot-product for an example frame. The energy characterization, area breakdown and throughput are also shown in FIG. 7. The accelerator can process 278-737 M events/s at different supply voltages and turning on early termination. The tracked moving trajectory is shown and only has a <5 pixel error compared to ground truth in a 640×480 frame, as illustrated in FIG. 8. In one example, a standard metric HOTA-0 was applied as an example evaluation method and achieves a score of 93.3. The tracked path of the bird is shown in FIG. 8 for different ET thresholds. The system achieves 158 TOPS/W average energy efficiency and the SCIM macro achieves 495 TOPS/W energy efficiency. A throughput of 278-730 M event/s is achieved and is equivalent to 2K frame/s speed. Frame-based inputs are also used to characterize the performance of dense computation and achieve energy efficiency of 46 TOPS/W for system and 86 TOPS/W for macro.

A table is shown in FIG. 8, which to compare with other state-of-the-art works. The system achieves the highest working frequency of 600 MHz at 0.64V. The object tracking system achieves 278 M event/s throughput, 158 TOPS/W, as well as a throughput density of frame data of 6.8 TOPS/mm2.

The present disclosure has described one or more configurations, and it should be appreciated that many equivalents, alternatives, variations, and modifications, aside from those expressly stated, are possible and within the scope of the invention.

It is to be understood that the disclosure is not limited in its application to the details of construction and the arrangement of components set forth in the accompanying description or illustrated in the accompanying drawings. The disclosure is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular configurations or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or configurations. Further, references to particular rotational or other movements (e.g., counterclockwise rotation) is generally intended as a description only of movement relative a reference frame of a particular example of illustration.

In some configurations, aspects of the disclosure, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, configurations of the disclosure can be implemented as a set of instructions, tangibly embodied on a non-transitory computer-readable media, such that a processor device can implement the instructions based upon reading the instructions from the computer-readable media. Some configurations of the disclosure can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the disclosure, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular configurations of the disclosure. Further, in some configurations, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as configurations of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

This discussion is presented to enable a person skilled in the art to make and use configurations of the disclosure. Various modifications to the illustrated examples will be readily apparent to those skilled in the art, and the generic principles herein can be applied to other examples and applications without departing from the principles disclosed herein. Thus, configurations of the disclosure are not intended to be limited to configurations shown, but are to be accorded the widest scope consistent with the principles and features disclosed herein and the claims below. The accompanying detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g. “one or the other but not both”) when preceded by terms of exclusivity, such as “either,” “one of,” “only one of,” or “exactly one of.”

Also as used herein, unless otherwise specified or limited, the terms “about” and “approximately,” as used herein with respect to a reference value, refer to variations from the reference value of ±15% or less (e.g., ±10%, ±5%, etc.), inclusive of the endpoints of the range. Similarly, the term “substantially equal” (and the like) as used herein with respect to a reference value refers to variations from the reference value of less than ±30% (e.g., ±20%, ±10%, ±5%) inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

What is claimed is:

1. A stochastic computing in memory (SCIM) system, the SCIM system comprising:
one or more stochastic number generators embedded in a memory array;
a processor; and
a memory configured to:
receive a plurality of data slices;
calculate a first dot product for a first data slice in the plurality of data slices using a first set of operands;
receive and store the first set of operands in a binary representation; and
convert the first set of operands into binary stochastic bitstreams using the one or more embedded stochastic number generators.

2. The SCIM system of claim 1, further comprising a sensor.

3. The SCIM system of claim 1, wherein each locally generated bitstream corresponds to an average of a corresponding stored operand.

4. The SCIM system of claim 3, wherein the average is a negative value or a positive value.

5. The SCIM system of claim 1, wherein the first dot product comprises a filter.

6. The SCIM system of claim 1, wherein the memory is further configured to:
calculate a second dot product for the first data slice in the plurality.

7. The SCIM system of claim 1, wherein the binary stochastic bitstreams are used to calculate subsequent dot products for additional data slices in the plurality of data slices.

8. The SCIM system of claim 1, wherein the plurality of data slices are generated as binary bitstreams by the one or more stochastic number generators.

9. The SCIM system of claim 1, wherein the memory comprises:
one or more AND gates configured as multipliers; and
one or more OR gates configured as accumulators.

10. The SCIM system of claim 9, further comprising:
additional logic gates configured to process stochastic bitstreams to determine an output.

11. The SCIM system of claim 10, wherein the additional logic gates are a serial counter.

12. The SCIM system of claim 1, wherein the memory is further configured to:
compare the first dot product to a pre-determined threshold; and
terminate further computations of the plurality of data slices upon determining the first dot product is below the pre-determined threshold.

13. The SCIM system of claim 12, wherein terminating further computations comprises terminating at least one: further dot product computations or further filter computations.

14. The SCIM system of claim 1, wherein the memory is further configured to reconstruct an image corresponding to an output of the first dot product.

15. A method for performing stochastic computing, the method comprising:
receiving a plurality of data slices;
calculating a first dot product for a first data slice in the plurality of data slices using a first set of operands;
receiving and storing the first set of operands in a binary representation; and
converting the first set of operands into binary stochastic bitstreams using one or more embedded stochastic number generators.

16. The method of claim 15, wherein each locally generated bitstream corresponds to an average of a corresponding stored operand.

17. The method of claim 15, wherein the first dot product comprises a linear convolutional filter.

18. The method of claim 15, further comprising:
calculating a second dot product for a second data slice.

19. The method of claim 18, wherein the second data slice comprises data that partially overlaps with data of the first data slice.

20. A stochastic computing in memory (SCIM) system for object detection, the SCIM system comprising:
an image sensor;
a processor electrically coupled to the image sensor; and
a memory configured to:
receive a set of binary operands obtained by the image sensor,
convert the set of binary operands to a stochastic bitstream using a stochastic number converter;
determine an output based on the stochastic bitstream; and
reconstruct an image corresponding to the set of binary operands based on the output.

21. The SCIM system of claim 20, further comprising one or more logic gates configured to process the stochastic bitstream to determine the output.
